(19) United States
(12) Patent Application Publication
(10) Pub. No.: US 2010/0234779 A1
(43) Pub. Date: Sep. 16, 2010

(54) PRESSURE ACTUATOR AND METHODS FOR APPLYING PRESSURE

(75) Inventors: Sima Asvadi, Eindhoven (NL); Mark Thomas Johnson, Eindhoven (NL); Mirielle Ann Reijme, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/377,683

(22) PCT Filed: Aug. 10, 2007
(86) PCT No.: PCT/IB07/53179

§ 371 Date: Feb. 17, 2009

(30) Foreign Application Priority Data
Aug. 17, 2006 (EP) 06119109.4

(51) Int. Cl. A61H 7/00

(52) U.S. Cl. 601/84

(57) ABSTRACT

Pressure actuator, provided with a carrier structure, shape memory material, integrated with and/or attached to the carrier structure, and at least one heating element in the vicinity of the shape memory material that is configured to at least locally vary the shape of the shape memory material that is in the vicinity of the heating element. In specific embodiments, the pressure actuator is provided with at least one heating element separate from the shape memory material, which at least one heating element may be configured to vary temperature within the shape memory material locally.

### FIELD OF THE INVENTION

The invention concerns a pressure actuator.

### BACKGROUND OF THE INVENTION

For certain healing and/or cosmetic processes, it is advantageous to apply pressure at certain locations on the body. However common pressure garments that are used are unable to facilitate the healing and/or cosmetic process adequately.

A goal of the invention is to provide a means for facilitating a healing and/or cosmetic process.

### SUMMARY OF THE INVENTION

This goal and other goals of the invention can be achieved individually or in combination, wherein the invention comprises a pressure actuator, provided with a carrier structure, shape memory material, integrated with and/or attached to the carrier structure, and at least one heating element in the vicinity of the shape memory material that is configured to at least locally vary the shape of the shape memory material that is in the vicinity of the heating element.

With the invention, it is possible to change the shape of the shape memory material, wherein the shape change of the shape memory material (and hence the pressure actuator) is limited to the shape memory material that is in the vicinity of the corresponding heating element, such that a local shape change is induced. Hence, pressure applied to a body can be controlled locally, thereby facilitating a healing and/or cosmetic process. In specific embodiments, by using heating elements separate from the shape memory material, local pressure can be advantageously controlled by controlling the heating elements individually, for example by means of active matrix addressing and/or a control circuit, providing an dynamically controlled pressure actuator.

Furthermore, said goals can be achieved individually or in combination by a method for applying pressure to a human or animal body, comprising a pressure actuator for applying said pressure, preferably by means of shape memory material, wherein the pressure actuator is at least partly flexible, wherein pressure applied to the body is controlled, at least in location and/or time by means of a circuit.

Also said goals can be achieved individually or in combination by a method for applying pressure to a human or animal body, wherein pressure is applied to said body via shape memory material, wherein the shape memory material is heated at a pattern along its surface such that the shape memory material changes shape locally, approximately according to said pattern.

Furthermore, said goals can be achieved individually or in combination by the use of shape memory material in devices for applying pressure to the body, wherein the shape memory material locally changes shape, at least in the direction of the body, preferably approximately perpendicular to the body.

Also said goals can be achieved individually or in combination by a computer program product that is configured to individually drive heating elements and/or groups thereof via a circuit, wherein the heating elements are configured to at least locally heat shape memory material for applying pressure to a human or animal body, wherein the computer program product is configured to control the local shape change of said memory material by said driving of said heating elements, at least in location and/or time.

### BRIEF DESCRIPTION OF THE DRAWINGS

In clarification of the invention, embodiments thereof will be further elucidated with reference to the drawing. In the drawing:

FIG. 1 shows a cross sectional side view of a pressure actuator;

FIG. 2 shows an illustrative example of the workings of one-way shape memory material;

FIG. 3 shows an illustrative example of the workings of two-way shape memory material;

FIG. 4 shows a diagram of the course of the shape change of a shape memory alloy as a function of temperature;

FIG. 5A shows a perspective view of an embodiment of a method of embroidering a wire of shape memory material;

FIG. 5B shows a perspective view of an embodiment of an embroidered wire of shape memory material;

FIG. 6 shows a top view of ribbons of shape memory material that are sewed on a carrier structure;

FIG. 7A shows a perspective view of twisted shape memory material fibres;

FIGS. 7B and 7C show perspective views of wrapped shape memory material fibres;

FIG. 8A to 8G show views of embodiments of pressure actuators;

FIG. 9 shows a cross sectional top view of a pressure actuator;

FIG. 10A shows a cross sectional side view of a pressure actuator;

FIG. 10B shows a cross sectional top view of a pressure actuator

FIG. 11 shows a cross sectional top view of a pressure actuator wherein a mesh of shape memory materials is shown.

### DETAILED DESCRIPTION OF THE EMBODIMENTS

In this description, identical or corresponding parts have identical or corresponding reference numerals. The exemplary embodiments shown should not be construed to be limitative in any manner and serve merely as illustration.

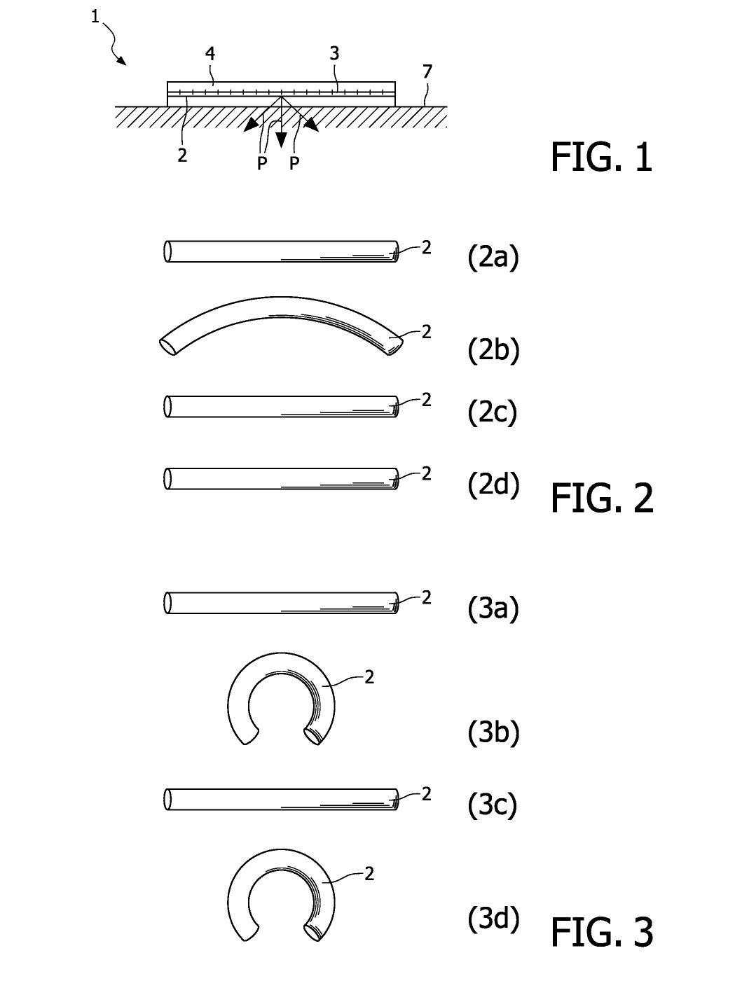

FIG. 1 shows a schematic cross section of an embodiment of a pressure actuator 1, in side view. The shown pressure actuator 1 comprises SMM (shape memory material) 2 and heating elements 3. A carrier structure 4 is provided to which the SMM 2 and heating elements 3 are attached. In this embodiment the SMM 2 is caused to change shape by heating. To that end, heating elements 3 are provided. In use, the changing of the shape of the SMM 2 causes the pressure actuator 1 to apply a pressure P, for example to the skin 7 of a person. In particular embodiments, the carrier structure 4 is at least partly flexible, e.g. to prevent too much counterforce on the SMM 2. This is also advantageous for wearing the structure like a garment or dressing.

In certain embodiments, applications for the pressure actuator 1 include massage bandage, therapeutic pressure bandage (e.g. to prevent thrombosis, bed soars), massage seat (e.g. in cars or airplanes), haptics transmitter, touch interactions for mobile devices and/or virtual reality, acupressure, pressure garments for burn patients, therapeutic garments, e.g. stockings for varicose vein patients, body contour correcting garments, pressure suits, and more. For example, pressure garments are already an important part for healing burn wounds, wherein the causing of scar tissue can be reduced by applying pressure the forming of scar tissue can be reduced.

Shape memory materials (SMM) 2 are materials with the unique property to recover a memorised shape subsequent to mechanical deformation by induced temperature change of the material. SMM comprises shape memory polymers (SMP) and shape memory alloys (SMA), which for example are commercially available in forms such as fibres, filaments, ribbons, tubes, plates and granules, and powders in the case of SMA. Known SMP's include polyurethane and polystyrene-block-butadiene. Known SMA's generally include NiTi-based or Cu-based alloys, for example Cu—Zn—Al or Cu—Al—Ni. As multiple SMM's can be applied according to the invention, clearly, the invention should not be limited to the mentioned SMM's.

In the field, both one-way SMA's and two-way SMP's are known. In particular embodiments the SMM 2 comprises one-way SMM 2, whereas in other embodiments, the SMM 2 comprises two-way SMM 2.

As can be seen from the illustrative example of FIG. 2, a one-way SMM 2 changes from a temporary deformed shape to a memorised shape by heating, when passing a temperature referred to as transition temperature (Tg). In FIG. 2, step a represents the memorised shape. In step b, the SMM 2 is deformed, wherein the energy produced by the mechanical deformation is stored in the material. This energy is then released upon heating in step c, facilitating the recovery process to the original memorised shape. For one-way polymers, as can be seen from step d, cooling the SMM 2 will in principle not affect the shape.

Two-way SMM's 2 have a reversible phase transformation. FIG. 3 illustrates the shape change process for a two-way SMM 2. Step a-c show the same effect as the one-way SMM 2 example of FIG. 2. As can be seen from FIG. 3, in step d cooling will change the shape of the SMM 2 back to the shape after mechanical deformation, without the need to apply external stress. The shape after mechanical deformation will be referred to as second memorised shape. For two-way SMM's 2, controlling the heating and cooling may be critical for the SMM's 2 response time. In general, SMM's 2 could be employed depending on parameters such as for example recovering strain, temperature control requirements, functional fatigue, etc. In specific embodiments, additive elastic material is employed in the pressure actuator 1 to assist and/or oppose certain shape changes of the SMM 2.

The temperatures that have to be applied depend on the properties of the SMM 2 that is used. Depending on the properties of the SMM 2 and/or temperatures applied to the SMM 2, the SMM 2 recover its memorised and/or second memorised shape fully or partly.

Pressure actuators 1 according to the invention are also meant to comprise one-way SMM's 2, that behave as two-way SMM's 2 as a result of combining them with textile material that has a Young's modulus that has a specific relationship with the Young's modulus of the concerning SMM 2, such as mentioned in the not yet pre-published European patent application number EP 05106301.4, herein incorporated by reference.

SMP's are polymers at which a recovery process can occur depending on the Tg (glass transition temperature) of the polymer. When passing Tg the mechanical properties of the particular SMP changes. Below Tg the SMP is relatively rigid and plastically deformable, whereas above Tg the material is soft and may be elastic and partly plastic, depending on the temperature relative to Tg. Two-way SMP's are known, for example from international patent application publication number WO 2004056547.

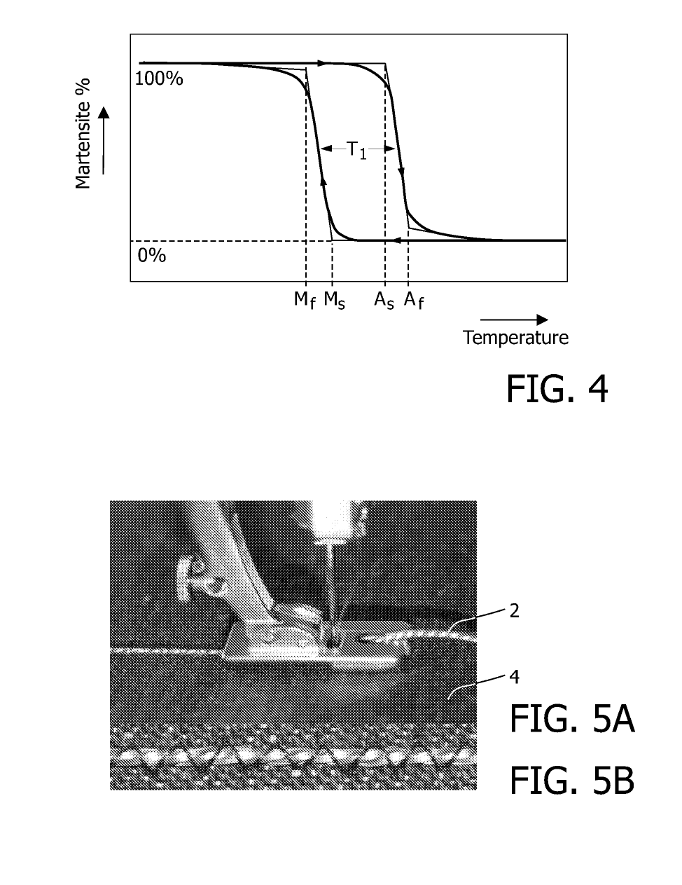

In general, SMA's have the same or similar temperature induced transition properties as SMP's. The memory effect is originated from a phase transition above a certain temperature, during which the material changes from Martensite to Austenite phase. The low temperature phase is the martensite (M) phase and the high temperature is referred to as the austenite (A) phase, as can be seen from the exemplary diagram in FIG. 4. The temperature ranges of these phases may vary depending on if the material is heated or cooled. In the diagram, Mₛ refers to martensite start, i.e. the start of the martensite phase, wherein the structure of the SMA starts to change during cooling, M_{f} refers to martensite finish, wherein the transition is finished, and Aₛ refers to austenite start and A_{f} to austenite finish, wherein transition starts and finishes during heating, respectively. SMA's are plastic and relatively easy to deform in the martensite phase, also referred to as below Tg, whereas at temperatures in the austenite phase, also referred to as above Tg, the material is elastic with a relatively large Young's modulus.

The shape change of SMM's 2 can be controlled using heating elements 3. Also the SMM's 2 can be heated by applying electricity to SMM's 2, particularly SMA's, as opposed to using separate heating elements 3. Said shape change can be used to apply pressure to a human or animal body. For example, a carrier structure 4 can comprise a fabric and/or bandage so that it can be worn on the body and allow shape change of the SMM 2. When heat is applied to the SMM 2 by heating, a shape change 2a, indicated by dotted lines, occurs in the SMM 2 which may cause a shape change 6a, also indicated by dotted lines, in another layer 6 of the pressure actuator 1. In this way the pressure actuator 1 may exert a varying pressure P, for example by a skin 7.

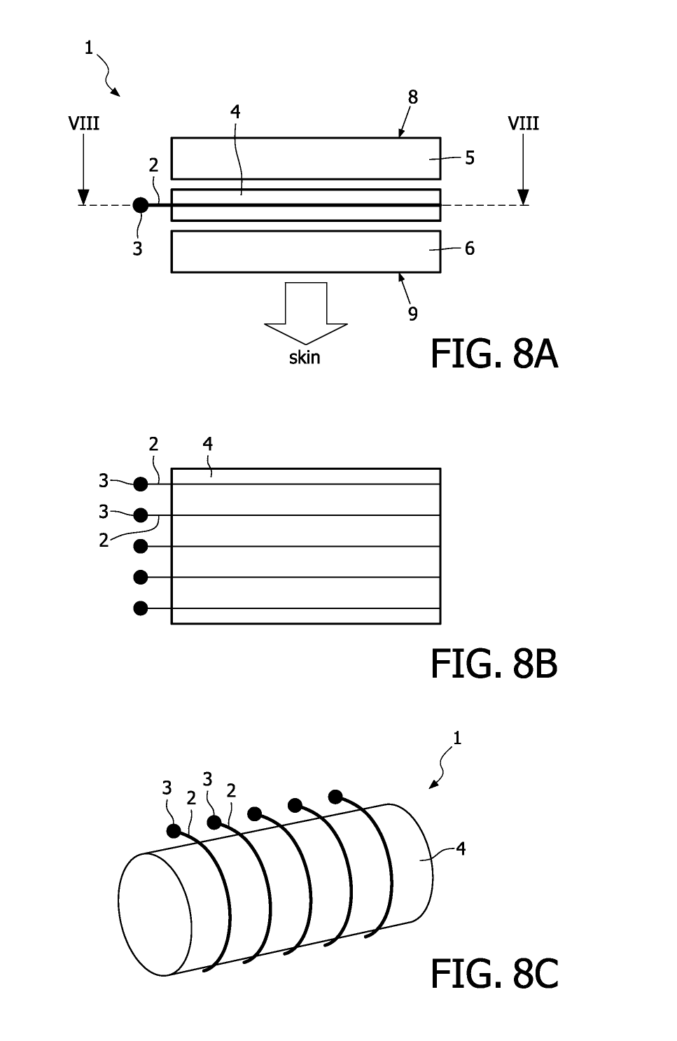

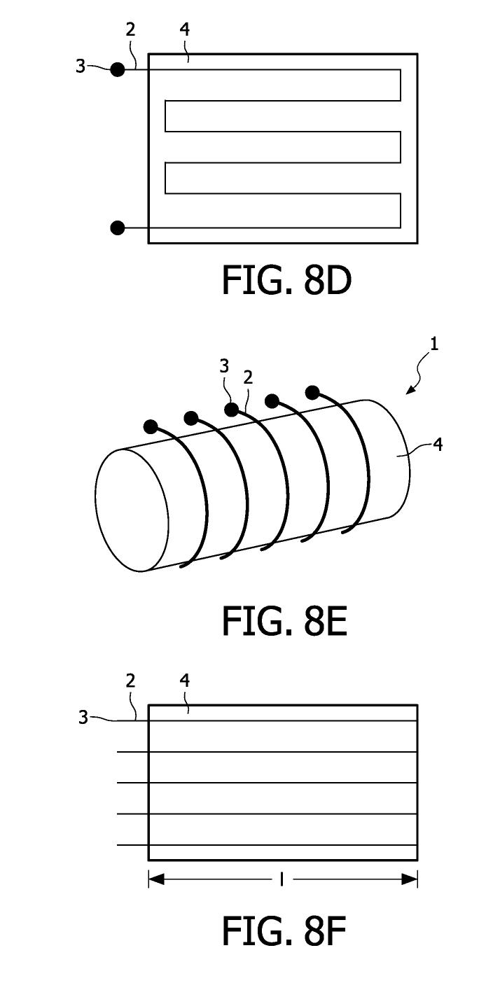

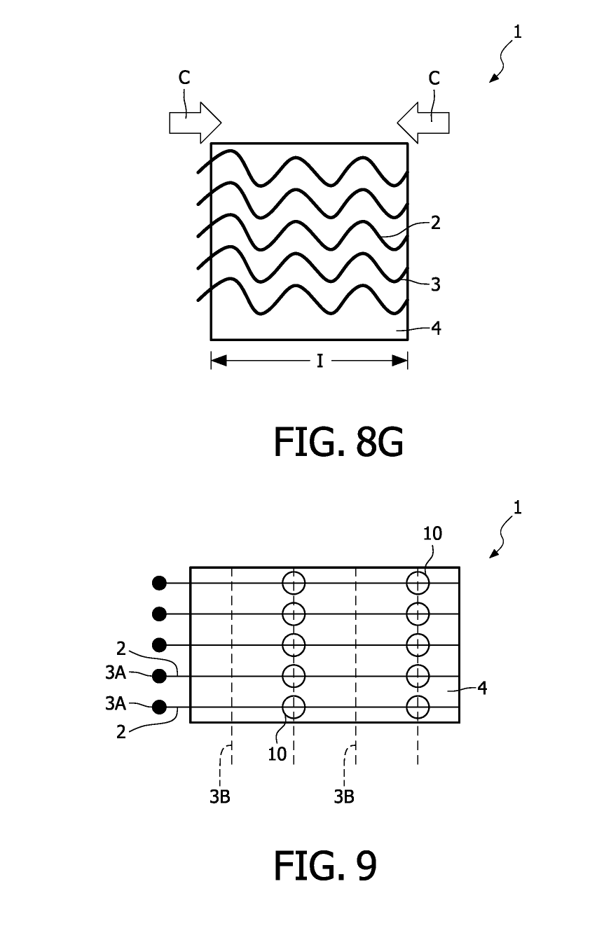

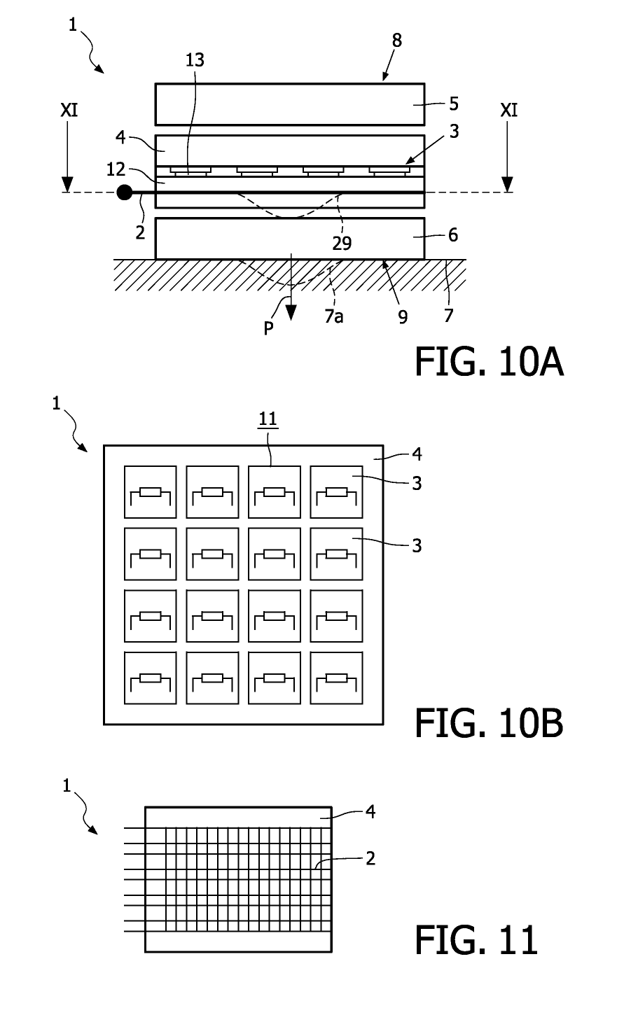

Carrier structures 4 that are suitable for the pressure actuator 1 can include, but are not limited to, bandage, plaster, plaster cast, dressings, textile, foil, woven and non-woven structures, plastics, particularly polymers, particularly polymer fabrics, e.g. nylon and polyester, yarns, fibres, wherein suitable fibers include natural textile fibers, such as cotton or wool fibers, regenerated fibers, such as viscose, and synthetic fibers such as polyester, polyamide (nylon) or polyacrylic fibers, rubbery substances, leather, animal skin. The carrier structure 4 may comprise holes for ventilation and/or cooling, insulation layers 5, cooling layers 6, etc (see for example FIG. 8A or 10A). The carrier structure 4 may also be transparent. In other cases, the carrier structure 4 is made of the SMM 2 and/or one or multiple heating elements 3, such that the SMM 2 and/or heating elements 3 have carrier structure function.

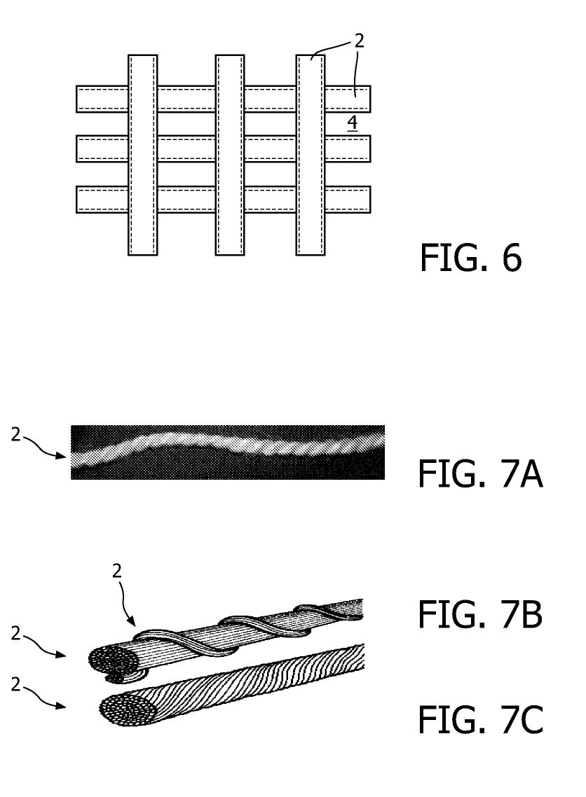

The attachment of SMM's 2 to or integration with textile materials can be done in various ways. The SMM's 2 can be embroidered, as indicated in FIG. 5, or for example sewn or stitched, as schematically indicated in FIG. 6, on the carrier structure 4. In FIG. 5, a SMM 2 is shown that comprises a yarn of fibres. Likewise, any shape of SMM 2 such as a surface shaped, tube shaped, ribbon shaped or wire shaped SMM 2 could be embroidered onto the carrier structure 4. In FIG. 6 ribbons or plates of SMM 2 are shown that are embroidered, for example by sewing. Alternatively, it can be glued to the fabric using special textile glues or other methods such as for example Velcro. The carrier structure 4 can for example be woven, knitted or non-woven. For example, the SMM 2 could be interwoven into the carrier structure 4.

The SMM 2 in fibre form can be twisted together, as can be seen from FIG. 7A or wrapped around other common textile fibres, as can be seen from FIGS. 7B and 7C. Alternatively the SMM 2 in fibre form could be combined with other mono filaments from textile sources to form a multifilament that could be woven, knitted or be held together by weaving of the yarn and/or twisting of the fibers. In further embodiments substantially the whole of the carrier structure 4 may be configured from SMM 2, or at least a substantial part of the carrier structure 4.

In an embodiment, the SMM 2 also comprises the heating element 3, as can be seen from FIG. 8A, thus providing integration of heating elements 3 in SMM's 2, i.e. integral heating elements 3 or integral SMM's 2, which will also be referred to as SMM's 2. When an electrical current is passed through the (integral) SMM 2, the SMM 2 warms up and will change shape, as can be seen from FIGS. 8B-G, wherein FIGS. 8B, 8D, 8F, 8G represent a top view of embodiments of cross section VIII-VIII shown in FIG. 8A. In other embodiments, FIGS. 8B, 8D, 8F, 8G may represent embodiments of cross section XI-XI (see FIG. 10A), except for the fact that the heating elements 3 are separately provided or may be added to the integration of heating elements 3 and SMM's 2.

In certain embodiments, for example embodiments as shown in FIG. 8A-G, heating of the SMM 2 will cause a length 1 reduction of the SMM 2. This illustrated in an exaggerated way in FIGS. 8F and 8G, wherein the carrier structure 4 contracts, indicated by arrows C. Also a memorised shape may be obtained that has a reversed effect, i.e. wherein heat causes an increase in length 1 of the SMM 2 element. Such linear length changes can be transformed into a pressure change, for example by configuring the material in the form of a bandage 1, e.g. to be wrapped around a body part like an arm or leg. This is illustrated in FIGS. 8C and 8E, wherein heating the SMM 2 results in a higher or lower pressure exerted by the bandage 1.

In embodiments of the pressure actuator 1 SMM's 2 are configured in the form of a meandering structure (FIG. 8D) or a spiral (FIG. 8F). In these embodiments, heating the SMM's 2 may result in a change in pressure at all or at least many points along the pressure actuator 1. In an embodiment, a plurality of SMM 2 wires or other types SMM's elements 2 are applied, for example to allow the possibility to realise different pressures, pressure changes and/or pressure directions at different points along the pressure actuator 1. These plurality of SMM's within the pressure actuators 1 may also have different construction properties, for example different masses and/or orientations, for example to allow different pressures. For example, a gradually increasing pressure gradient along the pressure actuator 1 can be realised.

In further embodiments, the temperature of the SMM's 2 is changed as a function of time and/or along the pressure actuator 1, in such a way, that a pulsing pressure is exerted by the pressure actuator 1. This may for example be applied with a single SMM wire 2. In other embodiments, pressure waves which move along the pressure actuator 1 are obtained, e.g. when a plurality of SMM wires 2 are arranged along the pressure actuator 1.

In particular embodiments separate layers 5, 6 are applied. For example between the outside surface 8 and the heating elements 3 of the pressure actuator 1, an insulating layer 5 can be arranged such that less power is needed to heat the SMM's 2 or to prevent heating of the skin 7. Furthermore cooling elements and/or a cooling layer and/or another insulation layer 6 may be applied, for example near the inside 9 of the pressure actuator 1, i.e. between the heating elements 3 and the skin 7 during use of the pressure actuator 1. This may prevent heating of the skin 7. In particular embodiments, these layers or elements 5, 6 may be used to cool and/or heat the SSM 2 more quickly, for example to be able to apply pressure changes more quickly. An example of a cooling element 6 that can be applied near a heating element 3 may be a Peltier device. This may be advantageous to apply certain pressure patterns as a function of time and/or along the pressure actuator 1 such as for example local pressure changes, pressure waves, pressures pulses, pressure gradients, etc.

In other embodiments the pressure actuator 1 comprises abovementioned integration of SMM 2 and integral heating elements 3A, which integration will be referred to as SMM 2, and separate heating elements 3B, as can be seen from FIG. 9. In these embodiment, the current passing through the SMM 2 may be insufficient to reach the temperature for changing the shape of the SMM 2. An additional array of heating elements 3B is arranged at a certain angle, for example approximately 90°, to the SMM's 2. At an intersection 10 of the SMM's 2 and heating elements 3B the SMM 2 is locally heated, by the accumulation of heat generated by the current through heating elements 3A/SMM2 and heating elements 3B, enough to locally change shape, i.e. exceed the T_{g}. The T_{g} is not exceeded at certain distances that are far enough from said intersections 10. In this way, a local shape change of the SMM 2 can be induced.

Depending on the properties of the SMM 2, i.e. the T_{g}, in particular embodiments the same principle as illustrated in FIG. 9 can be applied, wherein the SMM's 2 are not integrated with heating elements 3A, i.e. do not perform the double function of SMM 2 and heating elements 3. In such embodiments, the SMM's 2 (not comprising heating elements 3A) are locally heated by the heating elements 3B, enough to change shape locally.

In another embodiment, as shown in FIG. 10A, an array of heating elements 3 is provided. This allows for a local heating of the SMM 2 and thus, local changes in pressure, for example at different locations along the pressure actuator 1. These heating elements 3 can be driven, for example by a control circuit 11, to induce previously mentioned patterns such as pressure pulses, waves and/or gradients in a controlled way. Being able to apply and adjust local pressure is advantageous for many applications, for example in pressure garments for burn wounds or varicose patients, in Fig. correcting garments, and more. Said control circuit 11 could also drive the heating elements 3 based on input that is received from a muscle tone measurement device (not shown), such that an intelligent, dynamic pressure actuator 1 is achieved. In other words, using input from measurement devices, the pressure actuator 1 can react automatically to set the pressure P of the pressure actuator 1. Examples of such measurement devices may for example comprise, but are not limited to, muscle tone measurement devices, pressure measurement devices, (wherein said pressure may for example be surface pressure, weight or ambient pressure), wound measurement devices, fluid measurement devices and/or colour measurement devices. Such measurement devices may be connected to or integrated in the pressure actuator 1, for example via the control circuit 11, for example by means of connecting elements or by means of wireless communication.

An one or two-dimensional array of heating elements 3, such as shown in FIG. 10A, may provide a flexibility for creating pressure patterns along the pressure actuator 1 and/or as a function of time. In principle, only SMM's 2 in the vicinity of an activated heating element 3 will be deformed, such that pressure can be localised. For example by using a control circuit 11, relatively precisely localised pressures can be applied as a function of time with the aid of a large number of heating elements 3 in an array. For example, this embodiment could be useful in the field of haptics, since for example the touch of one or multiple fingers can be simulated. For example, a multiplicity of pressure waves can be exerted by the pressure actuator 1 along a surface of the pressure actuator 1 as a function of orientation, location and/or time.

In an embodiment, the SMM 2 is arranged in the carrier structure 4 such that in use the pressure change takes place perpendicular to the skin 7, i.e. to the surface 9 or 10 of the pressure actuator 1. Preferably, the pressure exerted to the skin 7 should preferably at least be directed towards the skin 7. In other words, in use a pressure change is exerted by the SMM 2 in a direction away from a surface 9 of the actuator 1, and more preferably perpendicular to said surface 9. Said pressure is indicated by arrows P in a cross sectional side view of a pressure actuator 1 in FIG. 1. Therefore, in an embodiment, the SMM 2 is arranged as wires in a mesh, as can be seen from the cross sectional top view illustrated in FIG. 11, corresponding to the cross section in FIG. 10A indicated by XI-XI. Of course, next to wired shapes, the SMM's 2 may be configured in any longitudinal shape to achieve a mesh, e.g. ribbons, tubes, etc. By being arranged in a mesh, the SMM 2 will have less tendency to rotate along its axis, such that an advantageous pressure direction P can be obtained. In other embodiments, preventing orientation and/or controlling the pressure P direction can be obtained by using ribbons and/or plates of SMM2 and/or embroidering the SMM 2.

In certain embodiments, a thermal conductor 12 is provided. This thermal conductor can be provided between the heating elements 3 and the SMM 2, as can be seen from 10A. Also a thermal conductor 12 can be arranged between the cooling element or layer 6 and the SMM 2. Thermal conductors 12 may be materials that have good conductivity such as for example a foil, oil and/or gel.

One or more insulation layers 5 and/or cooling layers and/or elements 6 may be provided, e.g. to prevent the heat from the heating elements 3 and/or the SMM 2 from reaching the skin 7. Note that in some circumstances, heat may intentionally be allowed to be passed to the skin 7, in which case the layer and/or elements 6 may be configured to allow the transfer of at least a portion of the generated heat to the skin 7.

In particular embodiments, the heating elements 3 may comprise any of the known heating principles, e.g. resistive heating, peltier elements, radiation heating, radio frequency heating, microwave heating, etc. In another embodiment, the heating elements 3 comprise thin film heating elements 3, also referred to as thin film resistive heating elements 3 or thin foil heating elements 3. This technology can be conveniently implemented on a flexible carrier structure 4 or substrate 4.

In an embodiment, the heating elements are addressed according to the same principles as used in thin film electronics technologies, such as for example active matrix displays in large area electronics, e.g. amorphous-Si, LTPS, organic TFT's, etc. For example, by using active matrix and/or large area electronics techniques, the number of drivers for the heating elements 3 may be reduced, as opposed by driving each, or particular groups of heating elements 3. According to this embodiment, the heating elements 3 may still be individually addressable allowing local pressure changes in the pressure actuator 1.

In still further embodiments, the drivers for driving the heating elements 3, i.e. in active matrix circuitry, may be integrated current sources for the heating elements 3, the application of which is known in the field of large area electronics.

In all of these and/or further embodiments, temperature sensors 13 may be provided. Temperature sensors 13 can be used to control the temperature of the heating elements 3. For example, by using these, the temperature that is needed to introduce pressure change can be limited to the temperature that is needed, such that power consumption and unnecessary heating, e.g. of the skin 7, can be limited. In an embodiment, the temperature sensor 13 is incorporated in the heating element 3, for example, such that an array of heating elements 3 and temperature sensors 13 can be manufactured by using large area electronics and/or active matrix technology. Also here, active matrix techniques can be implemented to drive both the sensors 13 and heating elements 3. In another embodiment the sensor 13 may be arranged in the vicinity of the SMM 2.

In another embodiment, as opposed to using an array of heating elements 3 to cooperate with one or multiple SMM's 2, a single heating element 3 is arranged to cooperate with multiple SMM's 2 which are configured to have different properties (e.g. mass, orientation, Tg), such that the pressure varies along the pressure actuator 1.

It should be considered that the invention is not limited to the field of medicine, cosmetics, but could also be applied in other fields, such as for example electronic equipment, fashion. The product may for example also be applied as a specific type of life style element and/or be incorporated into clothing, furniture, etc.

It shall be obvious that the invention is not limited in any way to the embodiments that are represented in the description and the drawings. Many variations and combinations are possible within the framework of the invention as outlined by the claims. Combinations of one or more aspects of the embodiments or combinations of different embodiments are possible within the framework of the invention. All comparable variations are understood to fall within the framework of the invention as outlined by the claims.

1. Pressure actuator, provided with a carrier structure, shape memory material, integrated with and/or attached to the carrier structure, and a plurality of heating elements in the vicinity of the shape memory material that is configured to at least locally vary the shape of the shape memory material that is in the vicinity of the heating elements.

2. Pressure actuator according to claim 1, wherein the plurality of heating elements and the shape memory material are separately arranged.

3. Pressure actuator according to claim 1, wherein the plurality of heating elements is configured to vary temperature within the shape memory material locally.

4. Pressure actuator according to claim 1, wherein the plurality of heating elements comprises an active matrix driven array of heating elements.

5. Pressure actuator according to claim 1, wherein the plurality of heating elements comprises thin film heating elements.

6. Pressure actuator according to claim 1, wherein the shape memory material is configured such that in use a pressure is exerted by the shape memory material in a controlled direction.

7. Pressure actuator according to claim 1, wherein the shape memory material is configured such that in use the pressure is exerted in a direction approximately perpendicular to a surface of the pressure actuator.

8. Pressure actuator according to claim 1, wherein the shape memory material is configured such that in use a pressure is exerted at least away from a surface of the pressure actuator, which surface is in contact with the body during use of the pressure actuator, preferably approximately perpendicular to said surface.

9. Pressure actuator according to claim 1, provided with at least one temperature sensor in the vicinity of the shape memory material and/or the plurality of heating elements.

10. Pressure actuator according to claim 1, wherein the at least one temperature sensor comprises an array of temperature sensors.

11. Pressure actuator according to claim 1, wherein the pressure actuator has at least an inside surface, that is applied to or near the body during use, wherein between the inside surface and the shape memory material a thermal isolator is provided.

12. Pressure actuator according to claim 1, wherein a control circuit is provided to drive the shape memory material and/or heating elements.

13. Pressure actuator according to claim 1, wherein the control circuit is configured to generate pressure patterns along the pressure actuator as a function of location, orientation and/or time.

14. Pressure actuator according to claim 13, wherein a measurement device is provided to provide input for said control circuit.

15. Pressure actuator according to claim 1, wherein at least one cooling element is provided near the plurality of heating elements and/or shape memory material.

16. Pressure actuator according to claim 1, provided with a thermal conductor between the plurality of heating elements and the shape memory material and/or between the at least one cooling element and the shape memory material.

17. Pressure actuator according to claim 1, wherein the shape memory material comprises at least one integral heating element.

18. Pressure actuator according to claim 1, wherein the carrier structure is at least partly flexible.

19. Pressure actuator according to claim 1, wherein the carrier structure is the SMM and/or the plurality of heating elements.

20. Garment and/or dressing with a pressure actuator including a carrier structure, a shape memory material integrated with and/or attached to the carrier structure, and a plurality of heating elements in the vicinity of the shape memory material that is configured to at least locally vary the shape of the shape memory material that is in the vicinity of the heating elements.

21. Method for applying pressure to a human or animal body, comprising a pressure actuator for applying said pressure by a shape memory material, wherein the pressure actuator is at least partly flexible, wherein pressure applied to the body is controlled, at least in location and/or time by a circuit.

22. Method according to claim 21, wherein the pressure is applied away from the pressure applying surface of the pressure actuator.

23. Method for applying pressure to a human or animal body, wherein pressure is applied to said body via shape memory material, wherein the shape memory material is heated at a pattern along its surface such that the shape memory material changes shape locally, approximately according to said pattern.

24. (canceled)

25. Computer program, when executed by a processor, configured to individually drive a plurality of heating elements and/or groups thereof via a circuit, wherein the heating elements are configured to at least locally heat shape memory material for applying pressure to a human or animal body, wherein the computer program product is configured to control the local shape change of said memory material by said driving of said heating elements, at least in location and/or time.
